(19) United States
(12) Patent Application Publication
(10) Pub. No.: US 2013/0140479 A1
(43) Pub. Date: Jun. 6, 2013

(54) BALL SEATS HAVING SEAL INTERFACE ELEMENT FOR PROLONGING THE SEAL BETWEEN BALL AND SEAT IN CORROSIVE ENVIRONMENTS AND METHODS OF USING SAME

(71) Applicants: Matthew D. Solfronk, Katy, TX (US); Jack Farmer, Tomball, TX (US)

(72) Inventors: Matthew D. Solfronk, Katy, TX (US); Jack Farmer, Tomball, TX (US)

(21) Appl. No.: 13/312,575

(22) Filed: Dec. 6, 2011

(51) Int. Cl. F16K 27/00; B21K 1/20

(52) U.S. Cl. 251/366; 29/890.124

(57) ABSTRACT

Apparatuses for restricting fluid flow through a well conduit comprise a tubular member, a seat, a plug element, and a seal interface element comprising a seal interface material. The seal interface material resists or retards corrosion by a corroding fluid of the portion of the sealing interface between the plug element and the seat. The seal interface material may be acid-resistant, hydrogen sulfide resistant, and/or the like depending on the type of corroding fluid that is present in the tubular member.

### BACKGROUND

1. Field of Invention

The present invention is directed to apparatuses for restricting fluid flow through a conduit in oil and gas wells and, in particular, to apparatuses having one or more seal interface materials disposed between the sealing interface of a plug element with a seat so as to resist or retard corrosion of the sealing interface by a corroding fluid.

2. Description of Art

Ball seats are generally known in the art. For example, typical ball seats have a bore or passageway that is restricted by a seat. The ball or plug element is disposed on the seat, preventing or restricting fluid from flowing through the bore of the ball seat and, thus, isolating the tubing or conduit section in which the ball seat is disposed. As force is applied to the ball or plug element, the conduit can be pressurized for tubing testing or tool actuation or manipulation, such as in setting a packer. Alternatively, the isolated zone of the wellbore can be treated with a corroding fluid such as an acid. Ball seats are also used in cased hole completions, liner hangers, flow diverters, frac systems, and flow control equipment and systems.

Although the terms “ball seat” and “ball” are used herein, it is to be understood that a drop plug or other shaped plugging device or element may be used with the “ball seats” disclosed and discussed herein. For simplicity it is to be understood that the terms “ball” and “plug element” include and encompass all shapes and sizes of plugs, balls, darts, or drop plugs unless the specific shape or design of the “ball” is expressly discussed.

### SUMMARY OF INVENTION

Broadly, the apparatuses for restricting fluid flow through a conduit or tubular member that are disclosed herein comprise a housing and a seat disposed therein. A seal interface material is disposed on or adjacent the seat and/or a plug element that is designed to land on the seat to restrict fluid flow through the tubular member. The seal interface material may be disposed on the plug element, the sealing surface of the seat, and/or above the sealing surface of the seat. As used herein, the term “sealing surface” refers to the contact area of the plug element with the seat. Thus, the seal interface materials is not required to be disposed directly between the seat and the plug element.

In certain embodiments, the seal interface material is resistant to corrosion by a corroding fluid such as acid or hydrogen sulfide. As used herein, the phrase “resistant to corrosion” refers to the ability of seal interface material to resist corrosion by the corroding fluid for a time period that is greater than the period of time necessary to corrode a seat or plug element that lacks the seal interface material.

### BRIEF DESCRIPTION OF DRAWINGS

FIG. 1 is a partial cross-sectional view of one specific ball seat disclosed herein shown prior to the plug member landing on the seat of the ball seat.

FIG. 2 is a partial cross-sectional view of the ball seat of FIG. 1 shown with the plug member landed on the seat of the ball seat.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

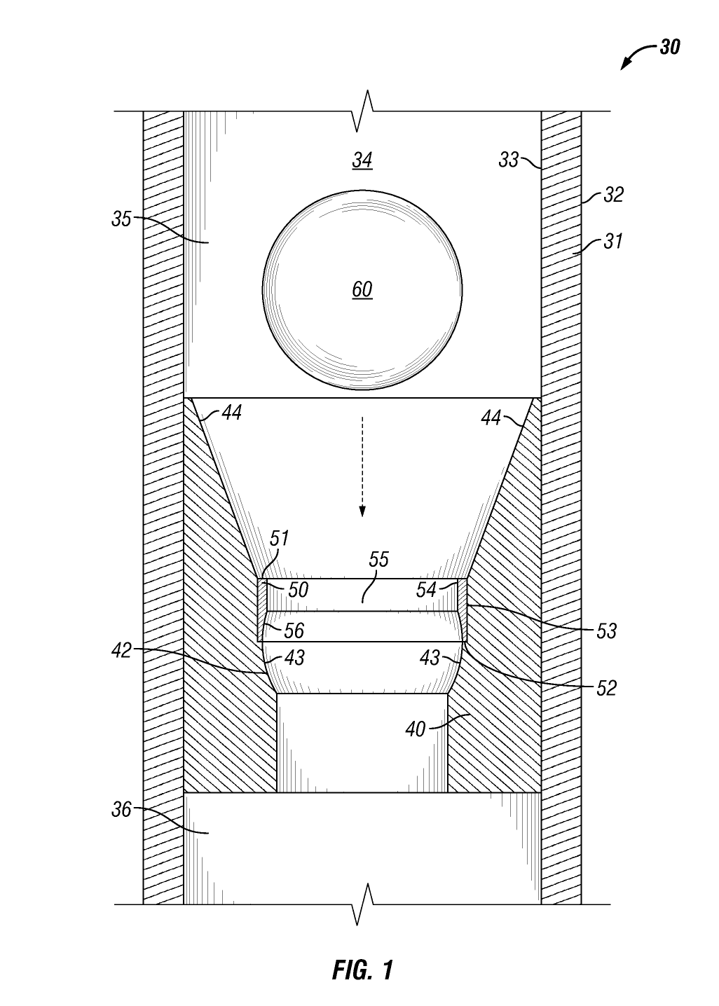

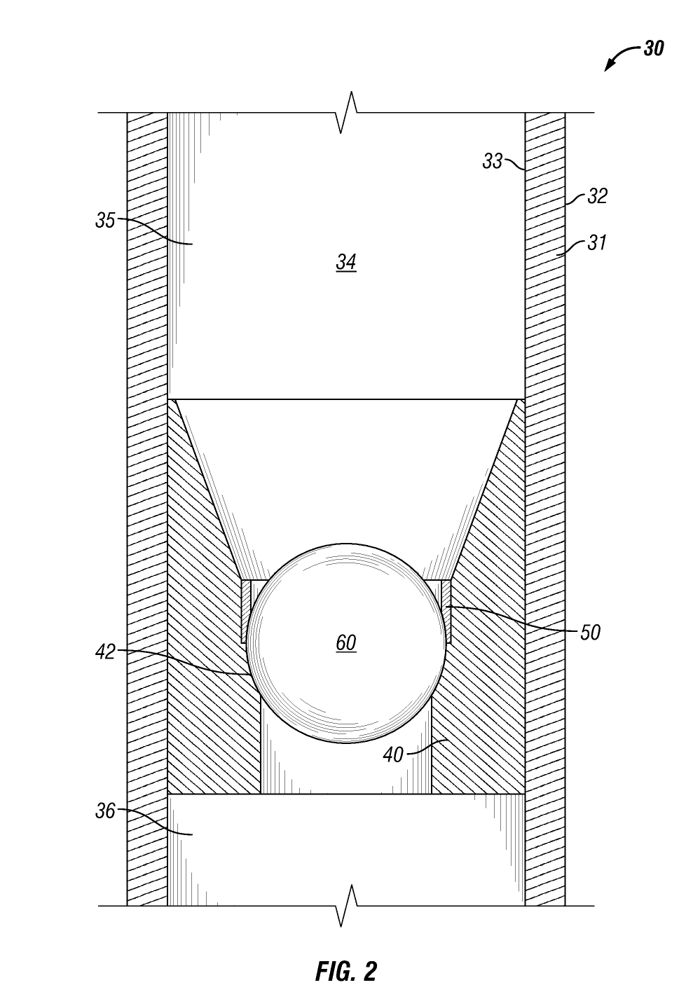

Referring now to FIGS. 1-2, an apparatus for restricting fluid flow is shown as ball seat 30 comprising tubular member 31 and seat member 40. Tubular member 31 comprises outer wall surface 32 and inner wall surface 33 defining bore 34. Bore 34 is divided into upper bore 35 and lower bore 36 by seat member 40. Seat member 40 can be secured to inner wall surface 33 through any method or device know in the art. In one particular embodiment, seat member 40 is secured to inner wall surface 33 by threads (not shown) on inner wall surface 33 and an outer wall surface of seat member 40. In another embodiment, seat member 40 is secured to inner wall surface 33 by bolts or other fasteners. In still another embodiment, seat member 40 is machined into inner wall surface 33 of tubular member such that tubular member 31 and seat member 40 are one piece, i.e., integral.

Seat member 40 comprises seat 42. In the embodiment of FIGS. 1-2, seat 42 is curved so as to be reciprocal in shape to plug member 60 shown as a spherical ball. Seat 42 provides sealing surface 43 for engagement with plug member 60. The term “sealing surface” is defined herein to mean the contact area between seat 42 and plug member 60. In the embodiment of FIGS. 1-2, seat member 40 further comprises ramp 44 which facilitates guiding plug member 60 onto seat 42.

In the embodiment of FIGS. 1-2, seal interface element 50 is disposed at an upper end of seat 42. As shown in FIGS. 1-2 seal interface element 50 comprises a sleeve having upper end 51, lower end 52, outer wall surface 53, and inner wall surface 54 providing opening or bore 55.

In the embodiment of FIGS. 1-2, seal interface element 50 is shaped at lower portion 56 of inner wall surface 54 to receive a portion of plug element 60. It is to be understood, however, that lower portion 56 can have any shape reciprocal to the shape of plug element 60, which is not required to be a spherical ball. In addition, lower portion 56 can provide a portion of sealing surface 43 such that seal interface element 50 is disposed on seat 42. However, seal interface element 50 is not required to provide a portion of sealing surface 43.

Seal interface element 50 comprises a seal interface material that is resistant to corrosion by one or more fluids that may be present in bore 34, and in particular, in upper bore 35, when plug element 60 is disposed on seat 42. Suitable seal interface materials include nitrile rubber (“NBR”), hydrogenated nitrile rubber (“HNBR”), perfluoroelastomer (“FFKM”), and fluoroelastomers (“FKM,” “FEPM”) such as those sold under the trademark AFLAS® available from Asahi Glass Co., Ltd. of Tokyo, Japan, and under the trademark VITON® available from E. I. du Pont de Nemours and Company. NBR and ALFAS® branded fluoroelastomers are suitable for high acid environments, and HNBR and VITON® branded fluoroelastomers are suitable for high hydrogen sulfide environments.

In operation, ball seat 30 is secured to a work or tubing string (not shown) and lowered into the wellbore (not shown). A downhole tool (not shown) is disposed in the work string above ball seat 30. After being disposed within the wellbore at the desired depth or location, a plug element shown as plug element 60 is dropped down the tubing string until it enters upper bore 35 and lands on seat 42 of seat member 40 (FIG. 2).

In one embodiment of operation, fluid, such as hydraulic fluid, is pumped down the tubing string causing downward force or pressure to act on plug element 60 to force plug element 60 into seat 42. The fluid pressure is then increased above plug element 60 until it reaches the actuation pressure of the downhole tool causing the downhole tool to perform its intended function, e.g., open a valve, set a packer, set a bridge plug, and the like.

Either after the downhole tool has performed its intended function, or during actuation of the downhole tool, a corroding fluid may be present in upper bore 35, either because it is included in the fluid being pumped down the tubing string, or because it entered into the tubing string from the formation. Generally, the corroding fluid corrodes or degrades plug element 60 until plug element 60 disintegrates, breaks apart, or is otherwise compromised such that a seal can no longer be maintained between plug element 60 and seat 42. To delay the amount of time for plug element 60 to be compromised by the corroding fluid, seal interface element 50 is disposed between plug element 60 and sealing surface 43 to restrict contact between the corroding fluid and sealing surface 43. Thus, sealing surface 43 maintains its integrity for a longer period of time as compared to no seal interface element 50 being present.

In another embodiment of operation, the fluid being pumped down the tubing string is an acid for acid treatment of the wellbore. In this embodiment, an acidic fluid is in constant contact with plug element 60 and seat member 40 causing corrosion of one or both of plug element 60 and seat member 40. Similar to the embodiment discussed in the preceding paragraph, seal interface element 50 is disposed between plug element 60 and sealing surface 43 to restrict contact between the acid and sealing surface 43 so that sealing surface 43 can maintain its integrity for a longer period of time as compared to no seal interface element 50 being present.

In another embodiment, the corroding fluid comprises hydrogen sulfide that corrodes one or both of plug element 60 or seat member 40. Thus, in this embodiment, seal interface element 50 is disposed between plug element 60 and sealing surface 43 to restrict contact between the hydrogen sulfide fluid and sealing surface 43 so that sealing surface 43 can maintain its integrity for a longer period of time as compared to no seal interface element 50 being present

It is to be understood that the invention is not limited to the exact details of construction, operation, exact materials, or embodiments shown and described, as modifications and equivalents will be apparent to one skilled in the art. For example, the corroding fluid is not limited to acid or hydrogen sulfide, but can be any fluid present in a wellbore that undermines the integrity of the plug element or the seat member. Similarly, the material forming seal interface element 50 is not required to be an acid-retarding material, or a hydrogen sulfide-retarding material, but can be any other material suitable for retarding corrosion or degradation by the particular corroding fluid.

Additionally, although the apparatuses described in greater detail with respect to FIGS. 1-2 are ball seats having a ball as their respective plug elements, it is to be understood that the apparatuses disclosed herein may be any type of seat known to persons of ordinary skill in the art that include a radially expandable seat member. For example, the apparatus may be a drop plug seat, wherein the drop plug temporarily restricts the flow of fluid through the wellbore. Therefore, the terms “plug” and “plug element” as used herein encompasses a ball as shown and discussed with respect to the embodiments of the Figures, as well as any other type of device that is used to restrict the flow of fluid through a seat. Further, in all of the embodiments discussed with respect to FIGS. 1-2, upward, toward the surface of the well (not shown), is toward the top of FIGS. 1-2, and downward or downhole (the direction going away from the surface of the well) is toward the bottom of FIGS. 1-2. However, it is to be understood that the seats may have their positions rotated. Accordingly, the ball seats can be used in any number of orientations easily determinable and adaptable to persons of ordinary skill in the art. Accordingly, the invention is therefore to be limited only by the scope of the appended claims.

What is claimed is:

1. An apparatus for restricting flow through a conduit, the apparatus comprising:
a housing having a longitudinal bore and a seat disposed within the bore, the seat dividing the bore into an upper bore and a lower bore, and the seat having a seat sealing surface for receiving a plug member, the plug member restricting fluid flow through the conduit when landed on the seat; and
a first seal interface element disposed at an upper end of the seat, the first seal interface element comprising a first seal interface material, the first seal interface material being resistant to corrosion by a first corroding fluid.

2. The apparatus of claim 1, wherein the first seal interface material is resistant to corrosion by an acid which comprises the first corroding fluid.

3. The apparatus of claim 1, wherein the first seal interface material is resistant to corrosion by a hydrogen sulfide fluid which comprises the first corroding fluid.

4. The apparatus of claim 1, wherein the plug element comprising a second seal interface material disposed on an outer wall surface of the plug element, the second seal interface material being corrosion resistant to a second corroding fluid.

5. The apparatus of claim 4, wherein the second seal interface material is resistant to corrosion by an acid which comprises the second corroding fluid.

6. The apparatus of claim 5, wherein the first seal interface material is resistant to corrosion by the acid which comprises the first corroding fluid.

7. The apparatus of claim 4, wherein the second seal interface material is resistant to corrosion by a hydrogen sulfide fluid which comprises the second corroding fluid.

8. The apparatus of claim 7, wherein the first seal interface material is resistant to corrosion by the hydrogen sulfide fluid which comprises the first corroding fluid.

9. The apparatus of claim 1, wherein the first seal interface element comprises a sleeve having a sleeve upper end, a sleeve lower end, a sleeve outer wall surface, and a sleeve inner wall surface, the sleeve inner wall surface defining a sleeve bore.

10. The apparatus of claim 9, wherein the sleeve inner wall surface comprises a lower portion having a shape that is reciprocal to a shape of the plug element.

11. The apparatus of claim 10, wherein the sleeve is disposed on a portion of the seat sealing surface.

12. An apparatus for restricting flow through a conduit, the apparatus comprising:
a housing having a longitudinal bore and a seat disposed within the bore, the seat dividing the bore into an upper bore and a lower bore, and the seat having a seat sealing surface for receiving a plug member, the plug member restricting fluid flow through the conduit when landed on the seat; and
a seal first interface element disposed on an outer wall surface of the plug element, the seal first interface element comprising a first seal interface material, the first seal interface material being resistant to corrosion by first corroding fluid.

13. The apparatus of claim 12, wherein the first seal interface material is resistant to corrosion by an acid which comprises the first corroding fluid.

14. The apparatus of claim 12, wherein the first seal interface material is resistant to corrosion by a hydrogen sulfide fluid which comprises the first corroding fluid.

15. The apparatus of claim 12, wherein the plug element is formed entirely out of the first seal interface material.

16. The apparatus of claim 12, further comprising a second seal interface element, the second seal interface element having a sleeve having a sleeve upper end, a sleeve lower end, a sleeve outer wall surface, and a sleeve inner wall surface, the sleeve inner wall surface defining a sleeve bore, the sleeve being formed out of a second seal interface material, the second seal interface material being corrosion resistant to a second corroding fluid.

17. The apparatus of claim 16, wherein the first and second seal interface materials are resistant to corrosion by an acid which comprise the first and second corroding fluids.

18. The apparatus of claim 16, wherein the first and second seal interface materials are resistant to corrosion by a hydrogen sulfide fluid which comprise the first and second corroding fluids.

19. A method of prolonging engagement of a plug element with a seat disposed in a tubular member, the method comprising:
(a) landing a plug element on a seat causing a first seal interface element to be disposed between a sealing surface defined by an interface of the plug element with the seat, the first seal interface element comprising a first seat interface material that is resistant to corrosion by a first corroding fluid;
(b) disposing the first corroding fluid with a tubular member, the first corroding fluid contacting the first seal interface element; and
(c) the first corroding fluid causing corrosion of the plug element or the seat at a first corrosion rate and the first corroding fluid causing corrosion of the first seal interface element at a second corrosion rate, the first corrosion rate being greater than the second corrosion rate.

20. The method of claim 19, wherein during step (c), the plug element is corroded by the first corroding fluid at the first corrosion rate.
